(19) United States
(12) Patent Application Publication
(10) Pub. No.: US 2025/0068833 A1
(43) Pub. Date: Feb. 27, 2025

(54) COMPOSE ASSISTANT MANAGER FOR AN APPLICATION

(71) Applicant: GOOGLE LLC, Mountain View, CA (US)

(72) Inventors: Janice An-Lei Wong, San Francisco, CA (US); Arielle Baio, Pacifica, CA (US); Juan Bernardo Mejia Reyes, Seattle, WA (US); Carlos Eduardo Knippschild, Kenmore, WA (US); Michael Blair Crouse, Seattle, WA (US); Dmitry Titov, Kirkland, WA (US); Justin Robert DeWitt, Bainbridge Island, WA (US); Tarun Bansal, Bellevue, WA (US); Young Bin Yu, San Jose, CA (US); Mingpu Hu, San Francisco, CA (US); Megan Michaux Jablonski, Seattle, WA (US); Travis Coe Service, Mountain View, CA (US)

(21) Appl. No.: 18/815,618

(22) Filed: Aug. 26, 2024

Related U.S. Application Data
(60) Provisional application No. 63/578,816, filed on Aug. 25, 2023.

(51) Int. Cl. G06F 40/174; G06F 40/40

(52) U.S. Cl. CPC G06F 40/174; G06F 40/40

(57) ABSTRACT

An application may receive a prompt from a user related to an input for a text field of digital content. An application may generate context data about the digital content. An application may provide the prompt and the context data to a generative language model. An application may receive a response generated by the generative language model and provide the response as a suggestion for the input for the text field.

### CROSS-REFERENCE TO RELATED APPLICATION

This application claims priority to U.S. Provisional Patent Application No. 63/578,816, filed Aug. 25, 2023, the disclosure of which is incorporated by reference herein in its entirety.

### BACKGROUND

Some web pages include text boxes that obtain text input from a user. Examples may include web pages that enable users to leave reviews about a product, a service, a place, etc., web pages that enable users to leave comments or replies to comments, web pages that enable users to post messages (e.g., web pages for social media websites), and/or web pages that include a survey, etc. A user can use a generative language model to help draft input content for a web page. However, the user may have to be relatively specific in their terminology when drafting their prompt and/or may have to perform multiple iterations with the language model to create a desired review. Further, obtaining contextual data from web content used by generative language models may pose one or more technical challenges relating to security.

### SUMMARY

This disclosure relates to a compose assistant manager for an application (e.g., a browser application) that integrates a generative model (e.g., a language model) for drafting content as input to a text field of digital content (e.g., a web page) that provides one or more technical benefits of maintaining the security of application content (e.g., web pages) and/or reducing the amount of computing resources (e.g., memory, CPU) consumed for generating and inserting generative content into (e.g., directly into) the text field of the digital content. The compose assistant manager may provide reduced overhead to the user when creating prompts and tailor the generated outputs to the context of the digital content. The compose assistant manager may generate one or more context signals (also referred to as context data) about the digital content (e.g., web page), and the compose assistant manager may transmit textual data received from a user (e.g., also referred to as a prompt or a user-provided prompt) and the content signals to the generative language model, which returns a model response that can be directly inserted into the text field. Put another way, the compose assistant manager assists the user in entering text into a text field provided by a computer system, and does so using technical information, specifically context information about the web page, which could be content from the web page.

In some aspects, the techniques described herein relate to a method including: receiving textual data from a user related to an input for a text field of digital content displayed on a user device; generating context data about the digital content; providing the textual data and the context data to a generative language model; receiving a response generated by the generative language model; and providing the response as a suggestion for the input for the text field.

In some aspects, the techniques described herein relate to an apparatus including: at least one processor; and a non-transitory computer-readable medium storing executable instructions that cause at the at least one processor to execute operations, the operations including: receiving textual data from a user related to an input for a text field of digital content displayed on a user device; generating context data about the digital content; providing the textual data and the context data to a generative language model; receiving a response generated by the generative language model; and providing the response as a suggestion for the input for the text field.

In some aspects, the techniques described herein relate to a non-transitory computer-readable medium storing executable instructions that cause at least one processor to execute operations, the operations including: receiving textual data from a user related to an input for a text field of digital content displayed on a user device; generating context data for the digital content; providing the textual data and the context data to a generative language model; receiving a response generated by the generative language model; and providing the response as a suggestion for the input for the text field.

The details of one or more implementations are set forth in the accompanying drawings and the description below. Other features will be apparent from the description and drawings.

### BRIEF DESCRIPTION OF THE DRAWINGS

FIG. 1A illustrates an example callout affordance for invoking a compose assistant manager according to an aspect.

FIG. 1B illustrates an example callout affordance for invoking a compose assistant manager according to an aspect.

FIG. 1C illustrates a compose assistant interface for receiving a prompt according to an aspect.

FIG. 1D illustrates a compose assistant interface for displaying a model response according to an aspect.

FIG. 1E illustrates an example of the text field inputted with the model response according to an aspect.

FIG. 1F illustrates a system having a compose assistant manager for a browser application that integrates a language model for drafting content as input to a text field of a web page according to an aspect.

FIG. 1G illustrates an example of context signals for generating a model response according to an aspect.

FIG. 1H illustrates an example of a triggering engine according to an aspect.

FIG. 1I illustrates an example of a web page with embedded resources according to an aspect.

FIG. 2 illustrates an example of a compose assistant interface according to an aspect.

FIG. 3 illustrates an example of a compose assistant interface according to another aspect.

FIGS. 4A to 4C depict a compose assistant interface rendered on a social media web page according to an aspect.

FIGS. 5A to 5F illustrate various aspects of a compose assistant interface according to an aspect.

FIG. 6 illustrates an example of a compose assistant interface according to another aspect.

FIG. 7 illustrates an example of a compose assistant interface according to another aspect.

FIG. 8 is a diagram that illustrates components of a computing system and server for implementing the concepts described herein according to an aspect.

FIG. 9 is a flowchart illustrating an example process for providing a compose assistant manager according to an aspect.

FIG. 10 is a flowchart of an example process for providing a compose assistant manager according to another aspect.

FIG. 11 is a flowchart of an example process for providing a compose assistant manager according to another aspect.

### DETAILED DESCRIPTION

This disclosure relates to a compose assistant manager for an application (e.g., a browser application) that integrates a generative model (e.g., a language model) for generating content for a text field and inserting (e.g., directly inserting) that content into the text field, which can provide one or more technical benefits of maintaining the security of web pages and/or reducing the amount of computing resources (e.g., memory, CPU) for generating and inserting generative content into one or more text fields of web content. The compose assistant manager may assist a user in leaving a review, commenting on an article, providing a survey response, drafting a social media post, filling out a customer complaint, and/or responding to a chat-bot, etc.

In some examples, a user may invoke the compose assistant manager expressly. For example, a user can right-click on a text field on a web page, and select a menu option (e.g., Help me write option), which causes the display of a compose assistant interface for receiving a prompt for the generative model. In some examples, the text field may be any type of input field configured to receive text from a user (e.g., via a keyboard, voice, touchscreen, etc.), where the text received by the user populates in the text field. In some examples, the text field is a free form text field. In some examples, the text field is a structured text field. In some examples, the text field is a multi-line text field. In some examples, the text field is a single-line text field. In some examples, the text field may be populated with data received via a microphone (e.g., via a voice assistant).

A user can provide a prompt (e.g., “write a five star review about this product”) in the compose assistant interface. For example, the compose assistant interface includes an input field that enables the user to draft a prompt, e.g., a natural language description about the type of content to be generated by the generative model. In response to submission to the prompt, the compose assistant manager may transmit the prompt and one or more context signals (also referred to as context data) about the underlying web page. The context data may include information about the subject matter of the web page. In response to the prompt and the context data, the generative model may generate and return a contextually relevant response, which can be directly inserted into the text box of the web page.

The compose assistant manager provides a technical solution that generates context data (e.g., one or more context signals) about the underlying web page, where the context signals are used to help the generative model create a contextually relevant response. In some examples, the context data includes a resource locator, page title, page content, a document object model (DOM) representation, and/or an accessibility content structure (e.g., accessibility tree). In some examples, the compose assistant manager may retrieve first page content for the web page having the text field and may retrieve second page content for one or more embedded web pages and include the first and second page contents in the context signals. In some examples, the web page includes one or more inline frames (e.g., an iframe) An iframe is a hypertext markup language (HTML) element that embeds another HTML document within a current page. Retrieving page content from embedded web pages may pose one or more technical challenges to maintaining security.

However, the compose assistant manager performs context extraction for the context signals that overcomes the technical challenges by requesting inner text for a specified host as well as requesting inner text for local same-origin iframes (e.g., all local same-origin iframes). Same-origin iframes may be iframes (e.g., embedded frames within a webpage) that share the same origin as the main webpage. The origin of a web page is determined by its protocol, hostname, and port number. In some examples, an embedded iframe is located on the same server or domain as the main web page. In some examples, an embedded iframe may have the same protocol, hostname and/or port number as the main web page. Inner text may refer to the visible text content within an HTML element and text from one or more child elements of the HTML element. The returned inner-text includes the combined inner-text of the iframes (e.g., all the iframes). The compose assistant manager retrieves the inner-text of the web page and the web page's inner-text is combined with the inner-text of an iframe (e.g., an embedded web page) as each iframe is detected. The compose assistant manager provides the context signals and user-provided prompt to the generative model. The generative model generates a model response and returns the model response to the compose assistant manager, where the compose assistant manager can insert the model response directly into the input text box (e.g., with or without user prompting).

The compose assistant manager may display the model response in the text field. The compose assistant interface may include one or more UI elements that enable the user to adjust the model response (e.g., more formal, less formal, expand, shorten, etc.), which causes the generative model to re-generate a model response. In some examples, the user may manually edit the model response. The compose assistant manager may include an insert control, which, when selected, causes the insertion of the model response into the text field on the web page. For example, in response to selection of the insert control, the compose assistant manager transfers the text of the input field of the compose assistant interface into the text field of the web page.

In some examples, the compose assistant interface may provide one or more suggested prompts for the user, which the user may select and/or edit. In other words, before a user has begun drafting a prompt in the input field on the compose assistant interface, the compose assistant interface may provide selectable suggested prompts, where selection of a suggested prompt causes the suggested prompt to be populated in the input field of the compose assistant interface. These suggested prompts may be based on the context signals obtained from the web page. For example, before the submission of a user prompt, the compose assistant manager may generate and provide a prompt suggestion request with one or more context signals to the generative model, which returns one or more suggested prompts to be displayed in the compose assistant interface. In some examples, the suggested prompts are selectable elements in the compose assistant interface. In some examples, in response to selection of a suggested prompt, the compose assistant manager may transmit the selected (suggested) prompt and the context signals to the generative model.

In some examples, the compose assistant manager may selectively trigger display of a callout affordance, where a user can interact with the callout affordance to invoke the compose assistant interface. For example, instead of the user directly invoking the compose assistant manager (e.g., by selecting a menu item associated with the compose assistant manager), the compose assistant manager may selectively display a callout affordance that informs the user about the compose assistant manager to help with drafting content for a text field. The callout affordance may be a UI object that is displayed on the web page at a location proximate to the text field. In response to user selection of the callout affordance (or a control on the callout affordance), the compose assistant manager may display the compose assistant interface to enable the user to submit a prompt to the generative model for creating content for the text field.

The compose assistant manager may determine if and/or when to display the callout affordance (or, in some examples, the compose assistant interface). The compose assistant manager may include heuristics and/or a machine-learning (ML) model that receives one or more signals and determines whether or not to render the callout affordance on the web page based on the signal(s). In some examples, the signals include signals about a text field on the web page, signals about the page content, and/or signals about the prior usage of the compose assistant interface with respect to the web page. In some examples, the prior usage signals may include one or more signals on whether the user has previously used the compose assistant interface (and/or previously disallowed the compose assistant interface) and/or one or more signals on whether other users has previously used the compose assistant on that particular text field.

In some examples, the generative model is a machine-learning (ML) model. In some examples, the generative model is a pre-trained large language model (LLM). In some examples, the generative model is a specially trained language model. The generative model may generate a high-quality response for the text field. In some examples, the generative model may be trained to generate responses for particular categories (types) of text fields. The generative model uses context signals from the web page to generate the content for the text field. The generative model may use context signals from the web page to determine a category associated with the text field (e.g., which category the text field represents). In some examples, a specially trained generative model for generating responses to particular categories of text fields may be smaller (e.g., in terms of required CPU and memory) and computationally faster (e.g., generating a response within a short period of time such as five or ten seconds) than generalist large language models, and may generate more relevant and higher quality responses that meet expectations for the category of the text field. Such relevant and suitable responses minimize user interactions to generate responses and provide a better human-machine guided process for generating content.

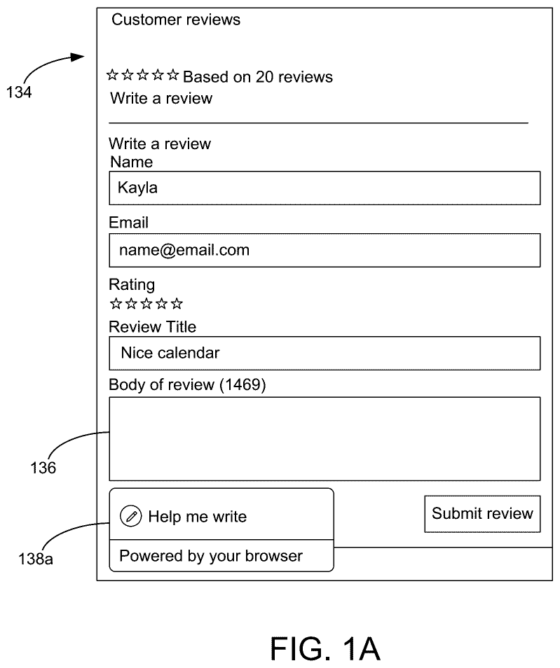

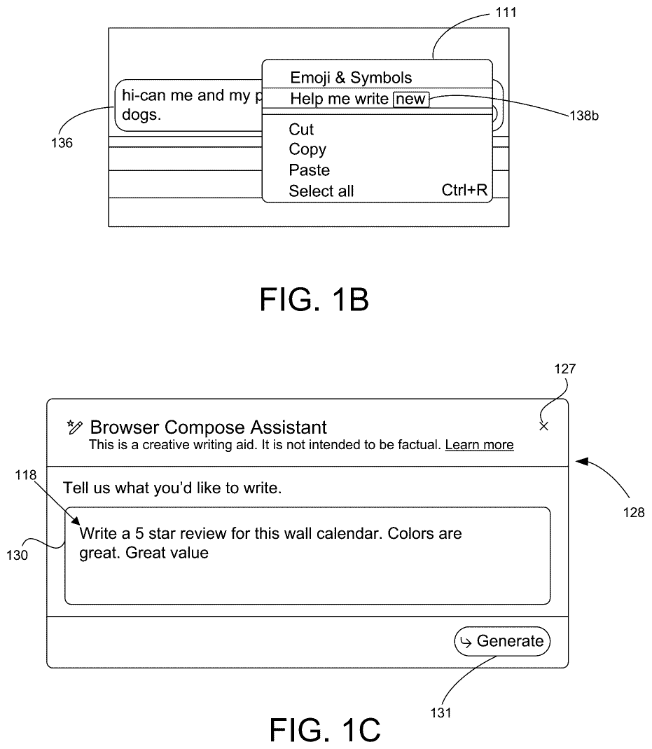

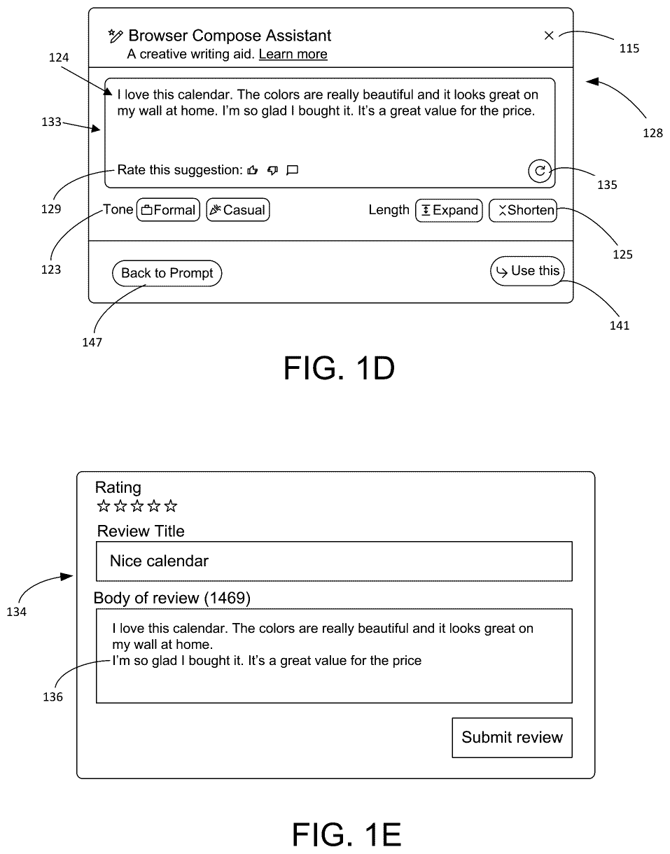

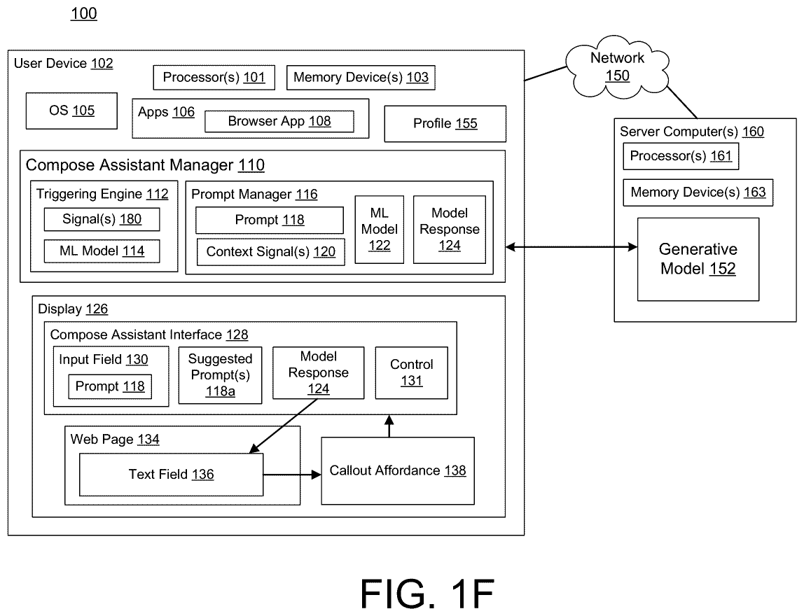

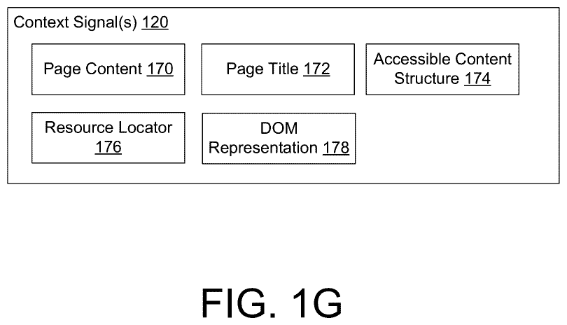

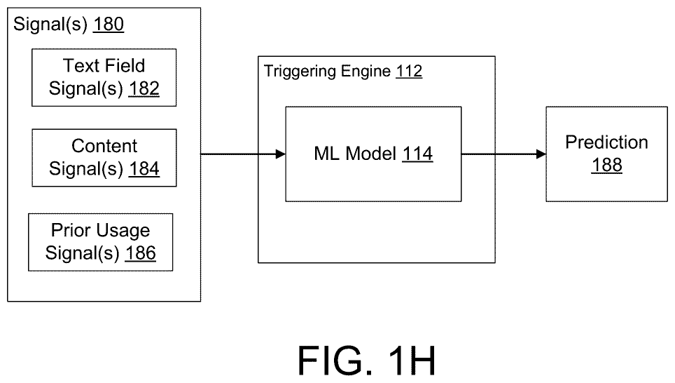

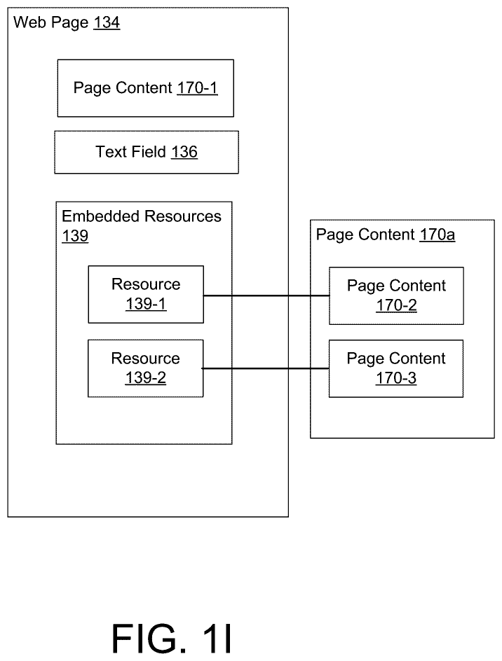

FIGS. 1A to 1I illustrate a system 100 having a compose assistant manager 110 of a browser application 108 for assisting a user in generating content for one or more text fields 136 of a web page 134. The compose assistant manager 110 can initiate a generative model 152 to generate a model response 124 for a text field 136 of a web page 134 and insert the model response 124 into (e.g., directly input) the text field 136. For example, a user may interact with the compose assistant manager 110 to help with drafting content for a text field 136 of a web page 134. In some examples, the web page 134 may be referred to as digital content. The term digital content may encompass web content, and, in some examples, non-web content.

The browser application 108, executable by a user device 102, may render a web page 134 on a display 126, as shown in FIGS. 1A and 1F. Although the example of FIG. 1A depicts a web page for writing a review, the web page 134 may be any type of web page 134. Furthermore, the techniques discussed herein may not be limited to a browser application 108, but any application that can render web content, or, in some examples, non-web content. The web page 134 includes a text field 136 configured to receive textual input from a user. In some examples, the text field 136 includes a free form input field. A free form input field includes an input field that receives unrestricted input from the user. In some examples, the text field 136 includes an input field that receives structured data. In some examples, the text field 136 includes a multi-line input field. In some examples, the text field 136 includes a single-line input field.

To access features of the compose assistant manager 110, the compose assistant manager 110 includes a triggering engine 112 configured to render a callout affordance 138 on a display 126 of the user device 102. A callout affordance 138 may be a user interface (UI) element, object, menu item, or a control that identifies the compose assistant manager 110. In some examples, the callout affordance 138 may be directly accessed by the user using one or more controls provided by the browser application 108. For example, as shown in FIG. 1B, the triggering engine 112 may render the callout affordance 138 as a menu item 138b (e.g., “help me write”) from a menu 111. In some examples, a user can right-click on the text field 136 on the web page 134, and the browser application 108 may display a menu 111 (e.g., a right-click menu) proximate to the text field 136, as shown in FIG. 1B. The menu 111 may include a menu item 138b, which, when selected, renders a compose assistant interface 128, as shown in FIGS. 1A and 1D.

In some examples, the triggering engine 112 may selectively trigger a display of a callout affordance 138. For example, as shown in FIG. 1A, the triggering engine 112 may display the callout affordance 138 as a selectable UI object 138a. In some examples, the triggering engine 112 detects a user interaction with the text field 136 (e.g., the user puts focus on the text field 136 such as placing the cursor on the text field 136), and, in response to the detected interaction, the triggering engine 112 may render the selectable UI object 138a. User selection on the selectable UI object 138a causes the compose assistant manager 110 to render the compose assistant interface 128, as shown in FIGS. 1C and 1F.

In some examples, the triggering engine 112 may determine if and/or when to display the callout affordance 138 (or, in some examples, the compose assistant interface 128). In some examples, the triggering engine 112 may detect a triggering event to display the compose assistant interface 128 based on one or more signals 180. In some examples, as shown in FIG. 1H, the triggering engine 112 includes a machine-learning (ML) model 114 configured to receive the signals 180 and compute a prediction 188 on whether to display the callout affordance 138 (e.g., the selectable UI object 138a of FIG. 1B). In some examples, the triggering engine 112 uses one or more heuristics using the signal(s) 180 to proactively render the callout affordance 138 (e.g., the selectable UI object 138a of FIG. 1B). In some examples, the triggering engine 112 uses a combination of heuristics and ML predictions to determine whether to display the callout affordance 138.

In some examples, the signals 180 include text field signals 182 (e.g., signals about a text field 136 on the web page 134), content signals 184 (e.g., signals about the page content), and/or prior usage signals 186 (e.g., signals about the prior usage of the compose assistant manager 110). In some examples, the prior usage signals 186 may include one or more signals on whether the user has previously used the compose assistant manager 110 (and/or previously disallowed the compose assistant manager 110) and/or one or more signals on whether other users has previously used the compose assistant on that particular text field 136 or web page 134.

The heuristics can include the outcome of an existing autofill capability. For example, the browser application 108 may include an autofill capability for text fields 136 that already uses multiple heuristics to identify target text-fields that matter for its purposes. A heuristic for proactively triggering the callout affordance 138 can be when the autofill capability does not trigger a suggestion (e.g., the autofill capability does not determine the text field 136 with focus to be appropriate for an autofill suggestion). The heuristics can include that the web page 134 is in a supported language. The heuristics can include that the compose assistant manager 110 is not suppressed by a supported reason (e.g., that the feature is disabled by the user, that the web page 134 or website (domain) is considered out-of-policy, etc.). The heuristics can include that use of the compose assistant manager 110 would not conflict with another browser feature. The heuristics may include that the text field 136 is not related to an enterprise or work productivity document (e.g., a word processing document, a slide deck, etc.). The heuristics may include that the text field 136 is not a prompt input box for a large language model (e.g., a text box that is designed to provide a prompt (query) sent to a large language mode). The heuristics may consider, with user permission, past user history (e.g., stored locally on the user's device). For example, if a user has used the compose assistant manager 110 on review websites but dismisses the callout affordance 138 on social media sites, the heuristics can enable the triggering engine 112 to render the callout affordance 138 for text fields related to product/service reviews but not to web pages related to social media.

The triggering engine 112 may use one or more of the heuristics in any combination to proactively render the callout affordance 138. In some examples, the triggering engine 112 may use one or more of the heuristics in any combination to proactively render the callout affordance 138 in response to the triggering engine 112 detecting user interaction with the text field 136 (e.g., focus being applied to the text field 136). In some examples, the triggering engine 112 may use one or more of the heuristics in any combination to proactively render the callout affordance 138 without detecting user interaction with the text field 136. (e.g., without focus being applied to the text field 136). In some examples, in response to an amount of textual data inputted by the user into the text field 136 achieving a threshold level, the triggering engine 112 may render a callout affordance 138. The callout affordance 138, when selected, is configured to render a compose assistant interface 128 for the text field 136, where the compose assistant interface 128 has an input field 130 configured to receive the prompt 118 from the user.

In some examples, as indicated above, the triggering engine 112 may include (or communicate with) a ML model 114 to generate a prediction 188 on whether to render the callout affordance 138. If the prediction 188 includes a probability that the user will likely use the compose assistant manager 110, the triggering engine 112 may render the callout affordance 138. In some examples, the ML model 114 may be trained with one or more of the heuristics (or any combination thereof) described herein to determine whether and when to trigger the callout affordance 138. For example, if the probability is high (satisfies a first threshold), the triggering engine 112 may trigger the callout affordance 138 (e.g., when the text field 136 receives focus). If the probability is not high but not low (fails to satisfy the first threshold but satisfies a second threshold), the triggering engine 112 may trigger callout affordance 138 if the user has typed a few characters or words in the text field 136 but then stops.

Referring to FIG. 1F, the compose assistant manager 110 includes a prompt manager 116. The prompt manager 116 generates context signals 120 about the web page 134. The context signals 120 may be referred to as context data. The context data includes information about the subject matter of the web page 134. In some examples, the prompt manager 116 generates the context signals 120 in response to the compose assistant manager 110 being invoked (e.g., when the callout affordance 138 is selected, and/or when the compose assistant interface 128 is rendered). In some examples, the prompt manager 116 generates the context signals 120 after the callout affordance 138 is rendered (e.g., UI object 138a) and before the callout affordance 138 is selected. In some examples, the prompt manager 116 generates the context signals 120 in response to selection of a generate control 131 on the compose assistant interface 128.

As shown in FIG. 1G, the context signals 120 may include a page title 172 of the web page 134, a page content 170 associated with the web page 134, and/or a resource locator 176 of the web page 134. In some examples, the context signals 120 include a DOM representation 178. In some examples, the context signals 120 include an accessible content structure 174. An accessible context structure 174 may be referred to as an accessible tree.

The prompt manager 116 provides a technical solution that generates the context signal(s) 120 about the underlying web page 134, where the context signals 120 are used to help the generative model 152 create a contextually relevant response. The prompt manager 116 performs context extraction that extracts page content for the web page 134 in a manner that maintains a security of the web page 134.

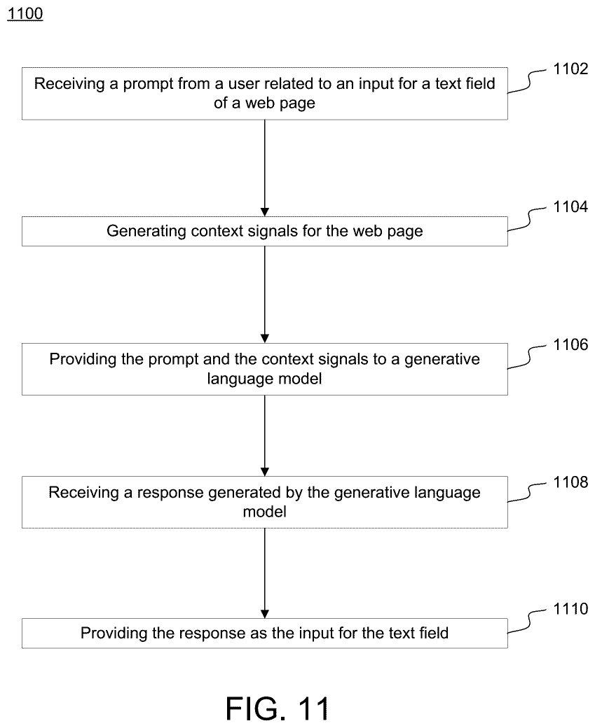

In some examples, as shown in FIG. 11, the page content 170 includes page content 170-1 of the web page 134 (e.g., a first web page) and page content 170a of one or more embedded resources 139, e.g., embedded into a structure of the web page 134. For example, the prompt manager 116 may retrieve page content 170-1 for the web page 134 with the text field 136 and may retrieve page content 170a for one or more embedded resources 139 (e.g., web pages). For example, the web page 134 may embed a resource 139-1 (e.g., a second web page) and a resource 139-2 (e.g., a third web page). The prompt manager 116 may retrieve the page content 170-1 of the web page 134, a page content 170-2 of the resource 139-1, and a page content 170-3 of the resource 139-2. In some examples, the page content 170-1, the page content 170-2, or the page content 170-3 may be referred to as inner text. Retrieving page content from embedded resources 139 (e.g., web pages) may pose one or more technical challenges such as security risks.

In other words, the web page 134 includes one or more inline frames (e.g., an iframe) (e.g., a hypertext markup language (HTML) element that embeds another HTML document (e.g., resource 139-1 or resource 139-2) within a current page (e.g., web page 134)). The prompt manager 116 performs context extraction for the context signals 120 that overcomes the technical challenges by requesting inner text for a specified host (e.g., web page 134) and inner text for local same-origin iframes (e.g., all local same-origin iframes). Same-origin iframes may be iframes that share the same origin as the main webpage (e.g., web page 134). The origin of a web page is determined by its protocol, hostname, and port number. In some examples, an embedded iframe is located on the same server or domain as the main web page. In some examples, an embedded iframe may have the same protocol, hostname and/or port number as the main web page. Inner text may refer to the visible text content within an HTML element and text from one or more child elements of the HTML element. The returned inner-text includes the combined inner-text of the iframes (e.g., all the suitable iframes). The prompt manager 116 retrieves the inner text of the web page 134 and the web page's inner-text is combined with the inner text of an iframe (e.g., an embedded resource 139) as each iframe is detected.

Referring to FIG. 1F, in some examples, the prompt manager 116 includes a ML model 122. The ML model 122 may receive the context signals 120 as inputs such as the page title 172 of the web page 134, the page content 170 associated with the web page 134, the resource locator 176 of the web page 134, the DOM representation 178, and the accessible content structure 174. The ML model 122 may generate context data using the context signals 120 (or generate second context data (e.g., a smaller set of content data) using first context data (e.g., a larger set of content data)), where the context data generated by the ML model 122 includes a smaller subset of information than the context signals 120 and the context data is provided to the generative model 152. In some examples, the ML model 122 selects a subset of the information contained in the context signals 120, and the subset is provided to the generative model 152. In some examples, the ML model 122 generates a summary of the context signals 120, and the summary is provided to the generative model 152. By using a ML model 122 to generate or select a portion of the context signals 120, a smaller set of information may be provided to the generative model 152, which can provide one or more technical benefits of reduced computation cost for computing an inference by the generative model 152. In other words, a token size of a prompt that is provided to the generative model 152 can be reduced, which reduces the computational cost of generating a model response 124.

Referring to FIGS. 1C and 1F, the compose assistant interface 128 includes an input field 130 configured to receive a prompt 118 from a user. In some examples, the prompt 118 is referred to as textual data, e.g., data entered by a user. A user can provide a prompt 118 (e.g., “write a five star review about this product”) in the compose assistant interface 128. The prompt 118 may be a natural language description about the type of content to be generated by a generative model 152. For example, the user can type the prompt 118 or provide a voice command that inserts the prompt 118 into the input field 130.

Referring to FIG. 1C, the compose assistant interface 128 may include a generate control 131. In response to user selection on the generate control 131, the prompt manager 116 may transmit the prompt 118 and the context signals 120 to the generative model 152. In some examples, the generate control 131 may be inactive until the user provides text in the input field 130. Thus, the generate control 131 may be active (and selectable) after the user does enter text in the input field 130. In some examples, the compose assistant interface 128 may include an option (e.g., in 3-dot menu or the like) to enable or disable the compose assistant manager 110.

In response to the prompt 118 and the context signal(s) 120, the generative model 152 may generate a model response 124. The prompt manager 116 may receive the model response 124 from the generative model 152 and display the model response 124 in an interface 133 of the compose assistant interface 128, as shown in FIG. 1D.

As shown in FIG. 1D, the compose assistant interface 128 may include one or more UI elements that enable the user to adjust the model response 124 (e.g., more formal, less formal, expand, shorten, etc.), which causes the generative model 152 to re-generate a model response 124. In some examples, the user may manually edit the model response 124. Referring to FIG. 1D, the compose assistant manager 110 may include an insert control 141, which, when selected, causes the insertion of the model response 124 into the text field 136 on the web page 134, as shown in FIGS. 1E and 1F. For example, in response to selection of the insert control 141, the compose assistant manager 110 transfers the text in the compose assistant interface 128 into the text field 136 of the web page 134.

As shown in FIG. 1D, the compose assistant interface 128 may include an insert control 141. The insert control 141 inserts the text into the text field 136, replacing the prior text written by the user in the case that a user previously wrote text (vs. starting from scratch). If a user wrote text, the insert control 141 may say “Replace”; if not, the insert control 141 may say “Insert this”. If a user clicked on replace but had only a selection of a portion of the text (e.g., by highlighting the portion of the text), then only this text gets replaced (vs. the full text in the field). In some examples, the insert control 141 may close the compose assistant interface 128. If the user closes the compose assistant interface 128, e.g., by selecting a close control 127, before selecting the generate control 131, this may be a local signal used in the personal heuristics, as discussed above. In other words, with user permission, the triggering engine 112 may use this type of closing event to determine when to proactively show a callout affordance 138. FIG. 1E illustrates the inserted model response 124 in the text field 136 of the web page 134. The user can edit the response in the text field 136 of the web page 134.

The compose assistant interface 128 may also include controls for revising (editing) the model response 124 using the generative model 152. For example, as shown in FIG. 1D, the compose assistant interface 128 may include tone controls 123. The tone controls 123 may enable the user to make the response sound more formal, more casual, funnier, include emojis, etc. The compose assistant interface 128 may include length controls 125. The length controls 125 may enable the user to shorten or lengthen the model response 124. In response to a user selecting any of the tone controls 123 or length controls 125, the compose assistant manager 110 may provide a new model response 124. In other words, the selection of the tone controls 123 or length controls 125 may cause the generative model 152 to regenerate a model response 124 based on the value of the selected control. In some examples, if the selects the “lengthen” length control 125 more than once, the compose assistant manager 110 may suggest that the user use a generalist large language model (such as Bard, chat GPT) for a better back-and-forth experience.

In some examples, as shown in FIG. 1D, the compose assistant interface 128 may include a regenerate control 135. The regenerate control 135 may generate another text suggestion (e.g., a new model response 124). The compose assistant interface 128 may include a back control 147. The back control 147 may allow a user to go back and edit their prompt 118 in the compose assistant interface of FIG. 1D. The compose assistant interface 128 may include close control 115. The close control 115 may dismiss the compose assistant interface 128 and return the user to the text field 136. In some examples, the compose assistant manager 110 may store information relating to the use of the compose assistant manager 110 with respect to the web page 134 (e.g., particular text field 136) to help determine whether to render the callout affordance 138 for the user or other users in the future.

In some examples, the compose assistant interface 128 includes a feedback mechanism 129. The feedback mechanism 129 may enable users to rate text suggestions. The ratings can be used, with user permission, for additional training (e.g., a thumbs down or low rating can be used as an example of what not to generate for the prompt). The ratings can also be used, with user permission, to trigger the compose assistant manager 110 for this user. Thus, some implementations enable users to rate the suggested text output to help us improve future suggestions. Although a binary (thumbs up/thumbs down) feedback mechanism 129 is illustrated in FIG. 1E, numeric scale may also be used (e.g., number of stars, selection of one of a number of ratings, etc.).

Referring to FIG. 1F, the compose assistant interface 128 may provide one or more suggested prompts 118a for the user, which the user may select and/or edit. In other words, before a user has begun drafting a prompt 118 in the input field 130 on the compose assistant interface 128, the compose assistant manager 110 may provide selectable suggested prompts 118a, where selection of a suggested prompt 118a causes the suggested prompt 118a to be populated in the input field 130 of the compose assistant interface 128. These suggested prompts 118a may be based on the context signals 120 obtained from the web page 134. For example, before the submission of a user prompt 118, the compose assistant manager 110 may generate and provide a prompt suggestion request with one or more context signals 120 to the generative model 152, which returns one or more suggested prompts 118a to be displayed in the compose assistant interface 128. In some examples, the suggested prompts 118a are selectable elements in the compose assistant interface 128. In some examples, in response to selection of a suggested prompt 118a, the compose assistant manager 110 may transmit the selected (suggested) prompt 118a and the context signals 120 to the generative model 152.

In some examples, a suggested prompt 118a is a generic prompt to indicate to the user that the compose assistant manager 110 can help them write. In some examples, if the user has not started writing and invokes the compose assistant manager 110, the compose assistant manager 110 may render a set of rotating suggested prompts 118a based on the context signals 120 (e.g., sets of ˜5 prompts may be different if a user is writing a review vs. social media caption vs. filling a form). Thus, suggested prompts 118a can use page context or can be generic. The page context can include values the user has provided for other fields, e.g., the number of stars the user has provided already. The page context can include insights from other content on the web page. In some examples, the compose assistant manager 110 may analyze the user's writing history in a profile 155 (e.g., a local profile) (generated with user permission) and/or open tabs to provide personalized prompts, ensuring relevance and resonance with the user's intended audience. The reliance on user history can help keep the tone of the responses generated for the user consistent.

If the user is reviewing a product, the generative model 152 may return a well-structured review even if the user does not explicitly specify it is a review in the prompt 118. This context-aware approach can be beneficial even before the user types anything. For example, implementations may support a zero-state use case which provides a UI that includes generic text input suggestions. For instance, implementations may provide a suggestion of “write a constructive review” when the user is viewing a review web page. In some implementations, the generative model 152 can be further trained to provide input suggestions that are also context-aware. In that case, if the user is on a review page for a wooden dinner table, the zero-state example could be “write a 4-star review about this dining table” or “write a review about <product> that does not work as intended” when the user is viewing a web page for <product> that is not a review page (e.g., is a customer complaint page).

Disclosed implementations also reduce interactions of the user with the user device 102 to accomplish insertion of generated text into a text field 136 of a web page 134. In particular, other large language models are not integrated into the browser application 108 and a generated response must be copy-and-pasted. Disclosed implementations help users directly where they are writing. Initial text input is sourced directly from the web page's text field the user is working on and, once the generative model 152 provides a generated output text (a response) that is deemed acceptable by the user, it is directly inserted into the same text field 136. Disclosed implementations can generate relevant ideas to get a user to start writing, adapt to the response to the user's voice, and give a user a first draft to edit. Whether a user is someone who likes to share witty comments to their friends about a piece of web content, who tries to file a complaint to a store, or simply want to craft a more heart-felt RSVP note to a wedding invitation, compose assistant manager 110 may be a dependable writing assistant that is built directly into a browser application 108.

The user device 102 may be any type of computing device that includes one or more processors 101, one or more memory devices 103, a display 126, and an operating system 105 configured to execute (or assist with executing) one or more applications 106, including the browser application 108. In some examples, a browser application 108 is a web browser configured to access information on the Internet. The browser application 108 may launch one or more browser tabs in the context of one or more browser windows on a display 126 of the user device 102. A browser tab may display content (e.g., web content) associated with a web document (e.g., web page, PDF, image, video, or generally any item identifiable by a resource locator, etc.) and/or an application such as a web application, progressive web application (PWA), and/or extension. A web application may be an application program that is stored on a remote server (e.g., a web server) and delivered over the network 150 through the browser application 108. In some examples, a progressive web application is similar to a web application but can also be stored (at least in part) on the user device 102 and used offline. An extension adds a feature or function to the browser application 108. In some examples, an extension may be HTML, CSS, and/or JavaScript based (for browser-based extensions).

In some examples, the user device 102 is a laptop computer. In some examples, the user device 102 is a desktop computer. In some examples, the user device 102 is a tablet computer. In some examples, the user device 102 is a smartphone. In some examples, the user device 102 is a wearable device. In some examples, the display 126 is the display of the user device 102. In some examples, the display 126 may also include one or more external monitors that are connected to the user device 102.

The processor(s) 101 may be formed in a substrate configured to execute one or more machine executable instructions or pieces of software, firmware, or a combination thereof. The processor(s) 101 can be semiconductor-based—that is, the processors can include semiconductor material that can perform digital logic. The memory device(s) 103 may include a main memory that stores information in a format that can be read and/or executed by the processor(s) 101. The memory device(s) 103 may store the browser application 108, the compose assistant manager 110 (and, in some examples, the generative model 152) that, when executed by the processors 101, perform certain operations discussed herein. In some examples, the memory device(s) 103 includes a non-transitory computer-readable medium that includes executable instructions that cause at least one processor (e.g., the processors 101) to execute operations. In some examples, the compose assistant manager 110 may be configured to communicate with one or more generative models 152. In some examples, the compose assistant manager 110 may enable the user to select one of a plurality of generative models 152 to use for generating input to a text field 136, where the plurality of generative models 152 include different LLMs. For example, the compose assistant interface 128 may provide a first selectable option associated with a first generative model, and a second selectable option associated with a second generative model. In response to selection of the first selectable option, the compose assistant manager may provide the prompt 118 and the context signals 120 to the first generative model. In response to selection of the second selectable option, the compose assistant manager may provide the prompt 118 and the context signals 120 to the second generative model.

The server computer(s) 160 may be computing devices that take the form of a number of different devices, for example a standard server, a group of such servers, or a rack server system. In some examples, the server computer(s) 160 may be a single system sharing components such as processors and memories. In some examples, the server computer(s) 160 may be multiple systems that do not share processors and memories. The network 150 may include the Internet and/or other types of data networks, such as a local area network (LAN), a wide area network (WAN), a cellular network, satellite network, or other types of data networks. The network 150 may also include any number of computing devices (e.g., computers, servers, routers, network switches, etc.) that are configured to receive and/or transmit data within network 150. Network 150 may further include any number of hardwired and/or wireless connections.

The server computer(s) 160 may include one or more processors 161 formed in a substrate, an operating system (not shown) and one or more memory devices 163. The memory device(s) 163 may represent any kind of (or multiple kinds of) memory (e.g., RAM, flash, cache, disk, tape, etc.). In some examples (not shown), the memory devices may include external storage, e.g., memory physically remote from but accessible by the server computer(s) 160. The processor(s) 161 may be formed in a substrate configured to execute one or more machine executable instructions or pieces of software, firmware, or a combination thereof. The processor(s) 161 can be semiconductor-based—that is, the processors can include semiconductor material that can perform digital logic. The memory device(s) 163 may store information in a format that can be read and/or executed by the processor(s) 161. In some examples, the memory device(s) 163 may store the generative model 152 that, when executed by the processor(s) 161, perform certain operations discussed herein. In some examples, the memory device(s) 163 includes a non-transitory computer-readable medium that includes executable instructions that cause at least one processor (e.g., the processor(s) 161) to execute operations.

Further to the descriptions above, a user may be provided with controls allowing the user to make an election as to both if and when systems, programs, or features described herein may enable collection of user information (e.g., information about a user's historical usage of the browser, a user's preferences, a user's current location, or other profile information), and if the features described herein are active. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

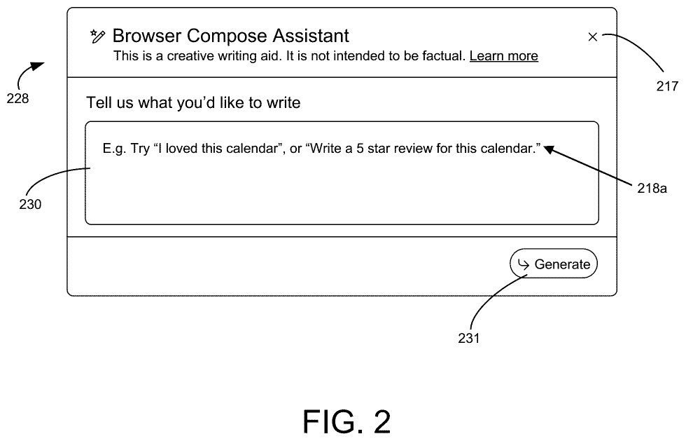

FIG. 2 illustrates a compose assistant interface 228 according to an aspect. The compose assistant interface 228 may be an example of the compose assistant interface 128 of FIGS. 1A to 1I and may include any of the details discussed with reference to those figures. As shown in FIG. 2, the compose assistant interface 228 includes an input field 230 configured to receive a prompt from a user. The compose assistant interface 228 displays a suggested prompt 218a in the input field 230, which the user may select and/or edit.

In other words, before a user has begun drafting a prompt in the input field 230 on the compose assistant interface 228, a compose assistant manager (e.g., the compose assistant manager 110 of FIGS. 1A to 1I) may provide a suggested prompt 218a. The suggested prompt 218a may be generated by a generative model (e.g., the generative model 152 of FIGS. 1A to 1I) based on one or more context signals (e.g., the context signals 120 of FIGS. 1A to 1I).

Referring to FIG. 2, the compose assistant interface 228 may include a generate control 231. In response to user selection on the generate control 231, the compose assistant manager may transmit the prompt and the context signals to the generative model. In some examples, the generate control 231 may be inactive until the user provides text in the input field 230. Thus, the generate control 231 may be active (and selectable) after the user does enter text in the input field 230. In some examples, the compose assistant interface 228 includes a close control 217. The close control 217 may dismiss the compose assistant interface 228 and return the user to the text field.

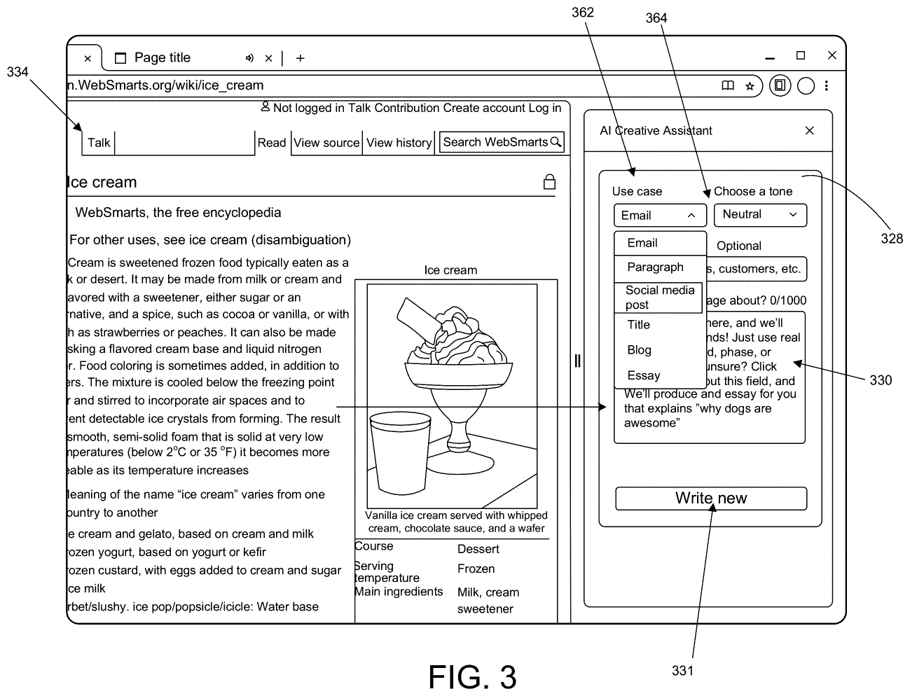

FIG. 3 illustrates a compose assistant interface 328 according to another aspect. In some examples, a user may invoke a compose assistant manager (e.g., the compose assistant manager 110 of FIGS. 1A to 1I) according to any of the techniques discussed herein, which may display the compose assistant interface 328. In some examples, the compose assistant interface 328 may identify a set of categories 362 (e.g., types) of a text field of a web page 334. The user may select one of the categories 362 from the set of categories. In some examples, the compose assistant interface 328 may identify a tone control 364 that enables the user to select a tone of a model response to be generated by a generative model. The compose assistant interface 328 may include an input field 330 configured to receive a prompt from a user. The compose assistant interface 328 may include a generate control 331. The generate control 331, when selected by the user, causes the compose assistant manager to transmit the prompt, the user selections made via the compose assistant interface 328, and the context signals generated by the compose assistant manager.

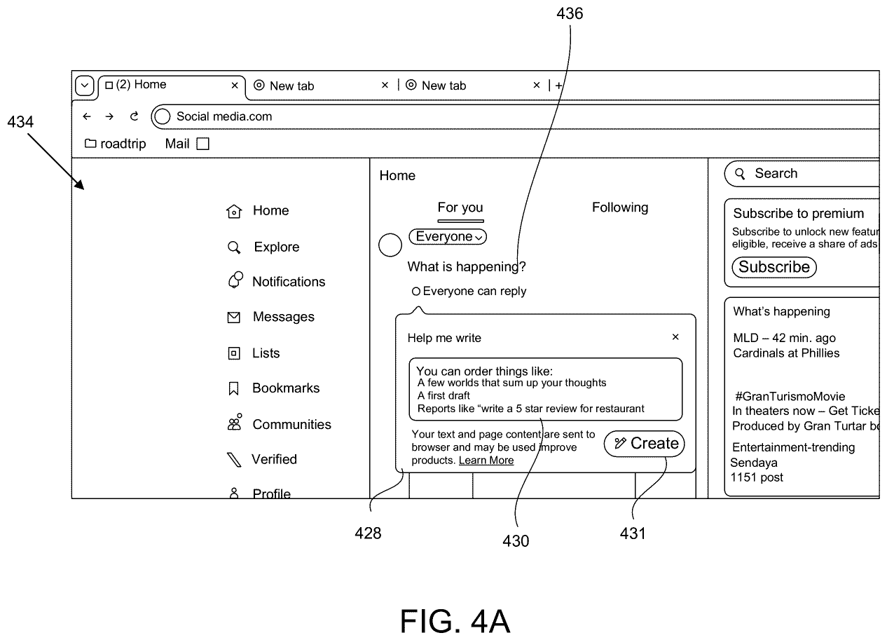

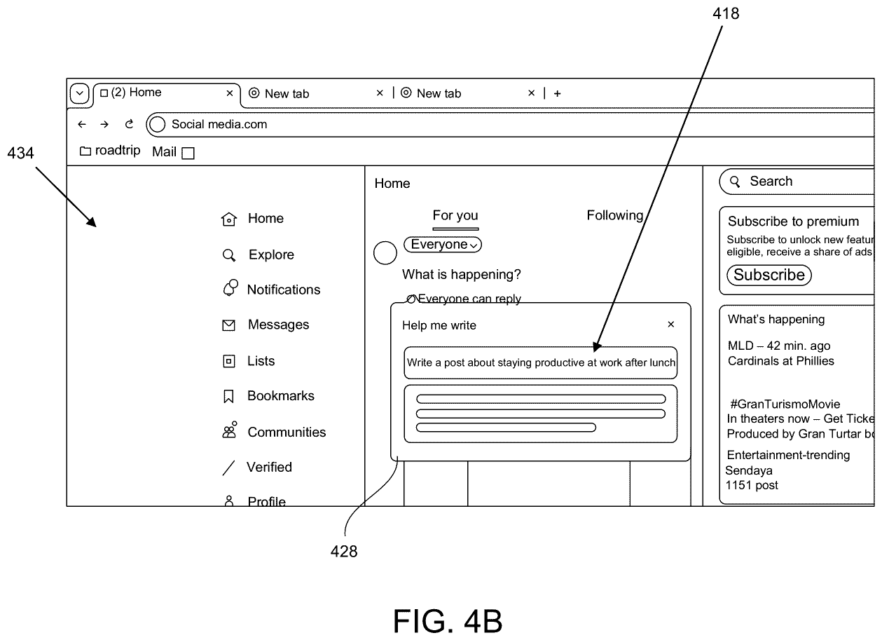

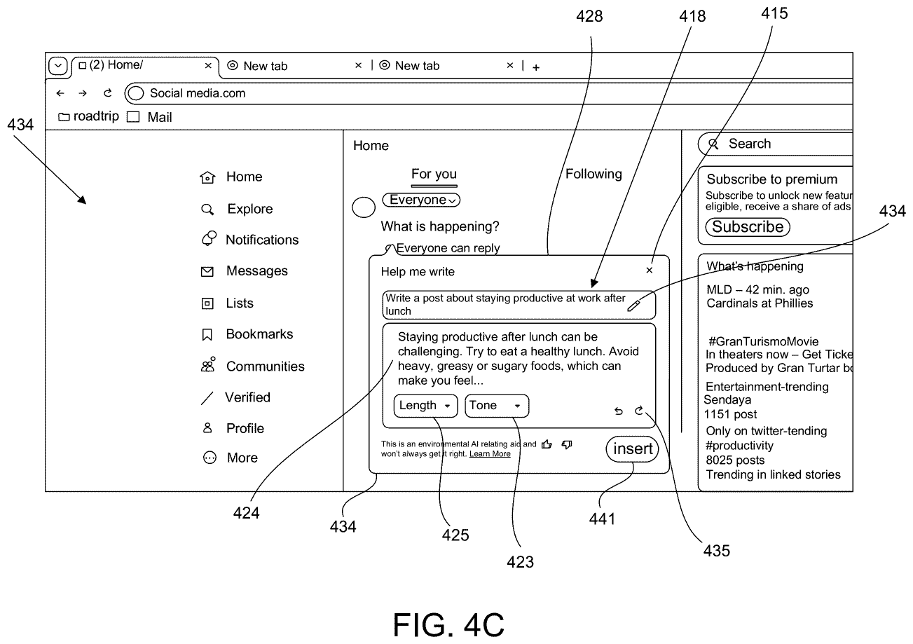

FIGS. 4A to 4C illustrate examples of a compose assistant interface 428 according to an aspect. A compose assistant interface 428 may be rendered on a web page 434 (e.g., a social media web page) to assist a user write a passage for a text field 436 on the web page 434. In some examples, the compose assistant interface 428 may be rendered when a compose assistant manager is invoked. The compose assistant manager may be invoked according to any of the techniques discussed herein.

As shown in FIG. 4A, the compose assistant interface 428 includes an input field 430 configured to receive a prompt 418 from a user. A user can provide a prompt 418 in the compose assistant interface 428. The prompt 418 may be a natural language description about the type of content to be generated by a generative model. For example, the user can type the prompt 418 or provide a voice command that inserts the prompt 418 into the input field 430.

The compose assistant interface 428 may include a generate control 431. In response to user selection on the generate control 431, a compose assistant manager (e.g., the compose assistant manager 110 of FIGS. 1A to 1I) may transmit the prompt 418 and context signals (e.g., the context signals 120 of FIGS. 1A to 1I) to a generative model (e.g., the generative model 152 of FIGS. 1A to 1I). In some examples, the generate control 431 may be inactive until the user provides text in the input field 430. In response to the prompt 418 and the context signal(s), the generative model may generate a model response 424. The compose assistant manager may receive the model response 424 from the generative model and display the model response 424 in the compose assistant interface 128, as shown in FIG. 4C.

As shown in FIG. 4C, the compose assistant interface 428 may include an insert control 441. The insert control 441 inserts the text into the text field 436. In some examples, the insert control 441 may close the compose assistant interface 428. The compose assistant interface 428 may also include controls for revising (editing) the model response 424 using the generative model. For example, the compose assistant interface 428 may include tone controls 423. The tone controls 423 may enable the user to make the response sound more formal, more casual, funnier, include emojis, etc. The compose assistant interface 428 may include length controls 425. The length controls 425 may enable the user to shorten or lengthen the mode response 424. In response to a user selecting any of the tone controls 423 or length controls 425, the compose assistant manager may provide a new model response 424. In other words, the selection of the tone controls 423 or length controls 425 may cause the generative model to regenerate a model response 424 based on the value of the selected control.

In some examples, the compose assistant interface 428 may include a regenerate control 435. The regenerate control 435 may generate another text suggestion (e.g., a new model response 424). The compose assistant interface 428 may include close control 415. The close control 415 may dismiss the compose assistant interface 428 and return the user to the text field 436.

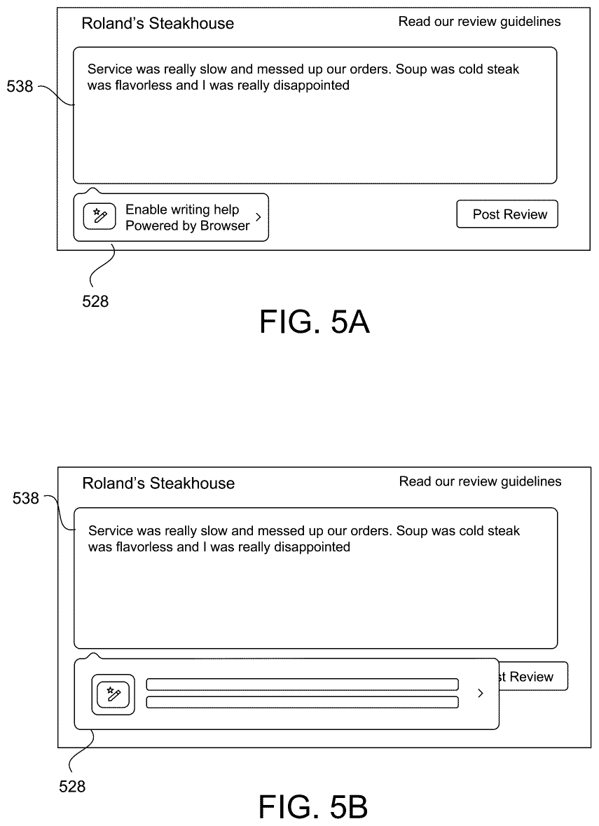

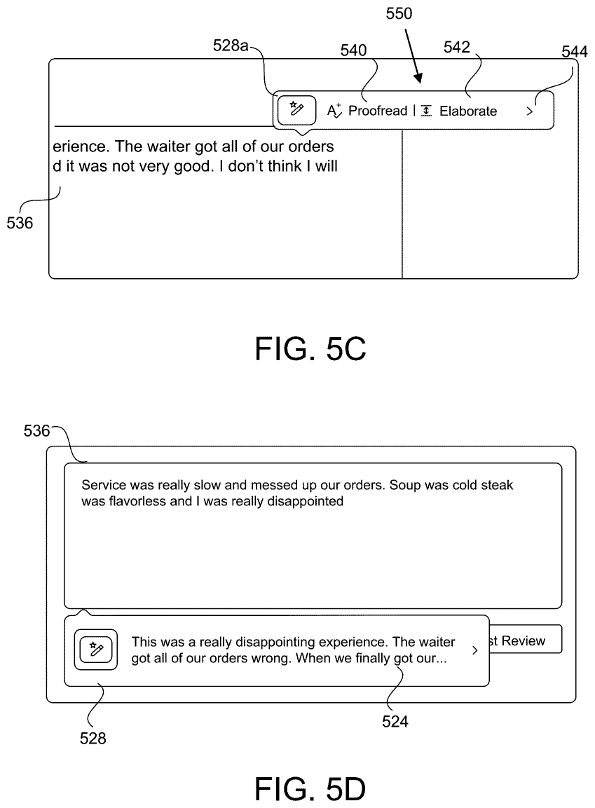

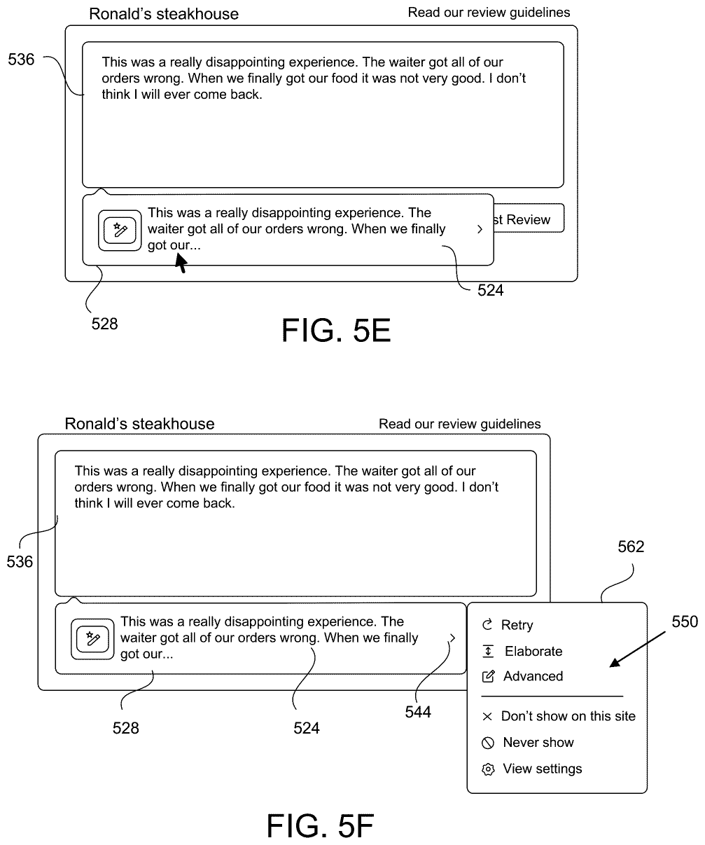

FIGS. 5A to 5F illustrate an example of a compose assistant interface 528 of a compose assistant manager according to an aspect. The compose assistant interface 528 may be rendered on a display with respect to a text field 136 of a web page. The compose assistant interface 528 may be triggered according to any of the techniques discussed herein. In some examples, the compose assistant interface 528 may be a UI dialog.

As shown in FIG. 5B, the compose assistant interface 528 may display a loading state while an initial writing suggestion 524 is being generated. In some examples, after a user has written a threshold level of words (an amount of textual data that achieves the threshold level) in a text field 538, an initial writing suggestion 524 may start generating. In some examples, as shown in FIG. 5C, after a user selects a threshold number of words in the text field 536, a compose assistant interface 528a may be displayed, where the compose assistant interface 528a may offer a user a set of actions 550, e.g., a proofread action 540, and an elaborate action 542. In some examples, the compose assistant interface 528a may include an expander control 544, which, when selected, offers additional actions.

In some examples, as shown in FIG. 5D, the initial writing suggestion 524 may be displayed in the compose assistant interface 528. In some examples, a compose assistant manager may transmit the text in the text field 536 and the context signals (e.g., the context signals 120 of FIGS. 1A to 1I) to a generative model. The generative model may generate a model response with the initial writing suggestion 524. In some examples, as shown in FIG. 5E, a user may hover a cursor over the compose assistant interface 528, which may provide a preview of the initial writing suggestion 524 in the text field 536. In some examples, the compose assistant manager may detect a cursor position on the suggestion (e.g., the initial writing suggestion 524), and, in response, to the cursor position within a boundary of the suggestion, the compose assistant manager may provide a preview of the suggestion in the text field 536. In some examples, as shown in FIG. 5F, in response to a user moving a cursor over the expander control 544, the compose assistant manager may render an action menu 562 displaying a set of actions 550.

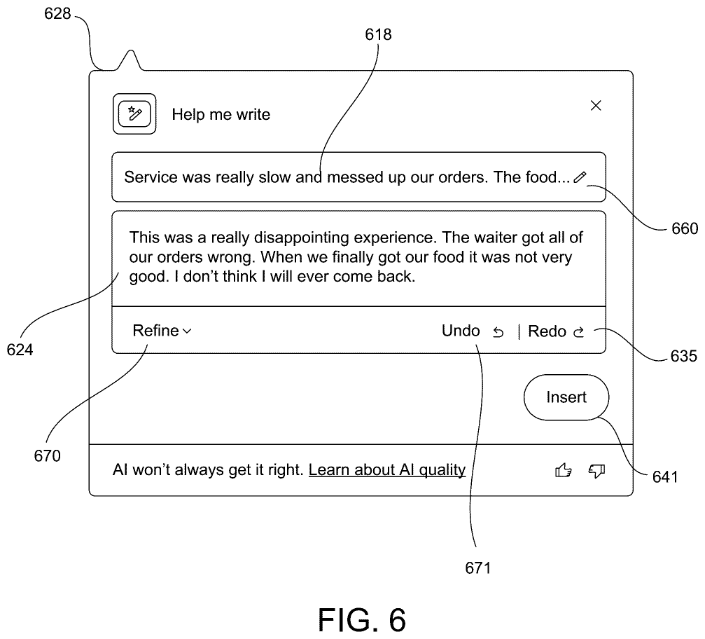

FIG. 6 illustrates a compose assistant interface 628 according to an aspect. The compose assistant interface 628 includes a prompt field 618 that shows the prompt, and an edit control 660 that, when selected, enables the user to edit the prompt. The compose assistant interface 628 displays a model response 624. The compose assistant interface 628 may display a series of controls such as refine controls 670 (which, when expanded, may show controls relating to shorten, length, tone adjustment, etc.), an undo control 671, and a redo control 635. The compose assistant interface 628 may include an insert control 641, which, when selected, inserts the prompt into the text field of the web page.

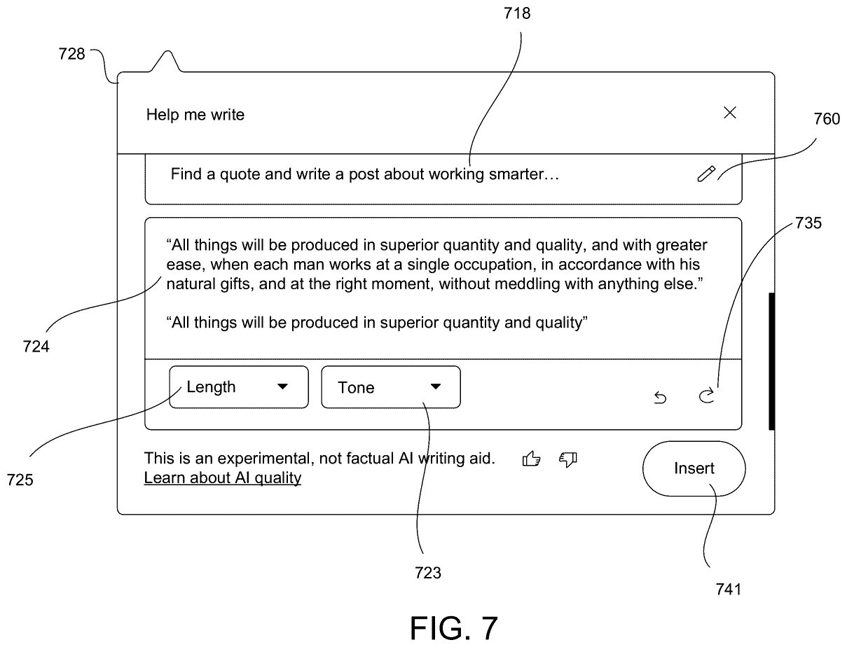

FIG. 7 illustrates a compose assistant interface 728 according to an aspect. The compose assistant interface 728 includes a prompt field 718 that shows the prompt, and an edit control 760 that, when selected, enables the user to edit the prompt. The compose assistant interface 728 displays a model response 724. The compose assistant interface 728 may display a series of controls such as a length control 725, a tone control 723, and a redo control 735. The compose assistant interface 728 may include an insert control 741, which, when selected, inserts the prompt into the text field of the web page.

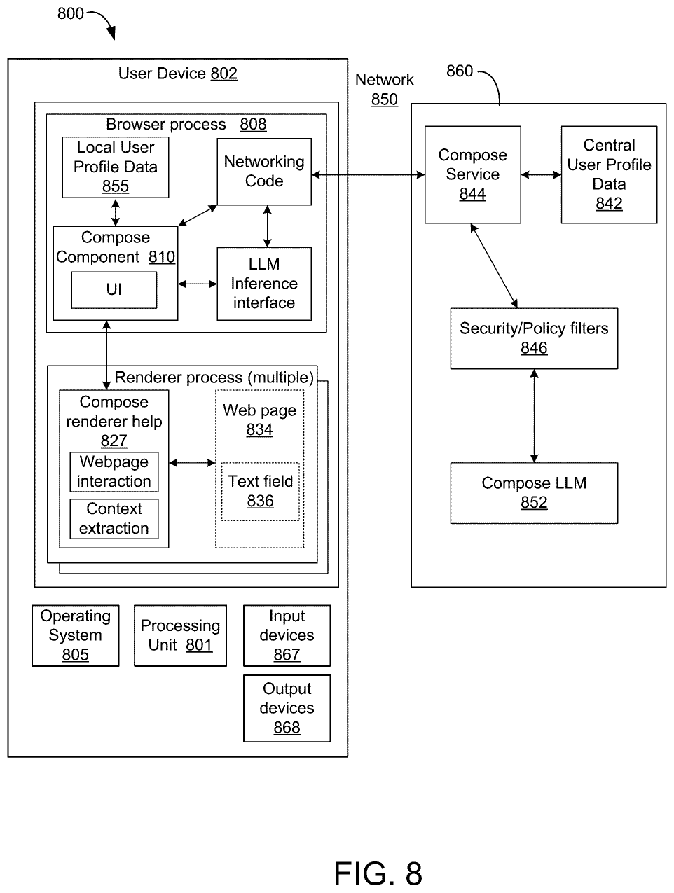

FIG. 8 is a diagram that illustrates a system 800 with a user device 802 and a server computer 860 for implementing the concepts described herein. In general, the user device 802 can represent any computing device that executes a browser application 808. As shown in FIG. 8, the user device 802 is configured to communicate with the server computer 860 and/or a resource provider (e.g., a web server) via a network 850. The user device 802 includes at least a browser application 808 and other applications (not shown). In some implementations, the browser application 808 is configured to manage resource content, such as web page content, provided by the resource provider (e.g., a web server). In some implementations, the browser application 808 is configured to operate as one of several applications executed via an operating system (O/S) 802.

Although not shown in FIG. 8, the user device 802 includes several hardware components including a communication module, one or more cameras, a memory, a processing unit 801, such as a central processing unit (CPU) and/or a graphics processing unit (GPU), one or more input devices 867 (e.g., touch screen, mouse, stylus, microphone, keyboard, etc.), and one or more output devices 868 (screen, speaker, vibrator, light emitter, etc.). The hardware components can be used to facilitate operation of the browser application 808, and/or so forth, of the user device 802. The user device 802 may also include an operating system 805. The browser application 808 includes a compose component 810 configured to generate the compose assistant user interfaces, e.g., as illustrated in the various figures.

The user device 802 may include local user profile data 855. The local user profile data 855 may be stored in a memory associated with the browser application 808 or may be stored in a memory accessible to the browser application 808. The local user profile data 855 may be a data source (or sources) for user-specific information that comes from the user's usage of the browser application 808, collected with user permission. The local user profile data 855 is an on-device storage. In some implementations the local user profile data 855 may be associated with an account profile, e.g., a user account for the server computer 860. In such implementations, some information may be stored in central user profile data 842. The user has control over what and when information is shared between the local user profile data 855 and the central user profile data 842. Sharing data from the local user profile data 855 (e.g., signals that help the compose assistant know when to trigger a callout affordance, signals that help define a tone for the user) with the central user profile data 842 enables the user to have a consistent experience with the compose assistant across user devices.

The browser application 808 includes a compose renderer helper 827. The compose renderer helper 827 runs in the renderer processes and performs operations related to the web page 834 and text field 836. The compose renderer helper 827 may include a web page interaction component, which is responsible for the interactions with the web page 834 that are needed for the user experience flow, such as monitoring the user interaction with text fields (e.g., text field 836), triggering the presentation of the callout affordance, extracts and inserts text from text fields, etc. The compose renderer helper 827 may include a context extraction component instrumented to capture a set of signals to aid in the generating of a response (text) for the text field. Once the user requests an LLM response, the content extraction component extracts all the expected context from the page to be packed along with the prompt. The context can include URL, title, and/or page contents, and/or other signals described herein. For the page content, the system may leverage different approaches to determine the most relevant part of the content. For example, the compose renderer helper 827 may utilize the DOM (document object model) or accessibility tree to identify which parts of the content are visible or not, which parts of the content are surrounding the input field (e.g., text field 836), and other key content parts of the page such as the heading fields. In such an implementation, the content extraction component may extract a DOM portion from the DOM representation for the context. In the context of a page related to a conversation, the context includes previous rounds in the conversation.

The context can include a main entity for the web page. For example, if the web page is a review web page for a vacuum, the main entity may be the vacuum or a vacuum. In some implementations, the generative language model may be trained to recognize a main entity in the content of a web page provided as context. Additionally, the compose renderer helper 827 may identify the text input fields and leverage their metadata, which can be used to classify their likely purpose in the context of the page paired with the user provided prompt. The browser application 808 will extract the raw signals and process the signals useful for creating the correct context to be used by the compose generative language model 852. This includes identifying the type of page, form and input field the user is typing into. The context can also be obtained from the website (e.g., the domain a web page is part of). For example, in implementations where the server computer 860 is associated with a search engine and the website is indexed, content from the search index for the domain could be used as context signals.

The context can also include user history signals, with the user's consent. The user history signals can include prior generated responses, e.g., so the compose generative language model 852 can mimic tone. For example, the context could include prompt packing to provide few-shot training for the compose generative language model 852. The prompt packing is used to bias the compose generative language model 852 to generating a response that is more similar to how this particular user has formatted responses in the past. In some implementations, the prompt packing can be stored as a state, e.g., in the local user profile data 855. The user history signals can include metadata from a shopping history. For example, if the browser application 808 is enabled to access shopping history, and the web page is a review for a product the user purchased (e.g., the user clicked on a link in an email that requests that the user leave a review; in this case the web page may be part of a custom tab associated with an email application), the shipping time may be known or calculable, and this information can be added as context and drawn upon by the compose generative language model 852 in generating the review (the response). Similarly, flight information could be used in responding to instructions for a rental car or hotel. The browser application 808 may include a settings user interface. The settings user interface may include a menu where users can enable and disable the compose assistant.

FIG. 8 illustrates some aspects of the server computer 860. For example, the server computer 860 may include a compose service 844, a security/policy filter 846, and a compose generative language model 852. The server computer 860 also includes one or more processors (not shown) and one or more memory devices (not shown). The compose service 844 may be server side business logic responsible for querying all the depended-on services and data sources to serve a user's request, including the collection of any further user data from the central user profile data 842 and requesting the compose generative language model 852 inference. The security/Policy filters 846 may ensure that the information received from and sent back to the user device 802 abides to all security, policies and legal requirements, e.g., avoiding sensitive categories and filtering unsafe content. In some implementations, the policy filter 846 may be known classifiers that identify negative negative/bad prompts and/or the type of the context of the page (adult content/violence/offensive). The policy filter 846 can be run against the prompt and its context and on the output from the compose generative language model 852. The policy filter 846 can prevent the compose generative language model 852 from providing an output to the user and instead return an error message indicating the prompt could not be processed.

The compose generative language model 852 is a generative language model custom-trained for the compose assistant to adapt it to the use-cases that the feature is targeting. The user cases are based on a purpose or type of the text field. For example, the purpose/type may be a review (product, place, travel, etc.), a comment (e.g., on a video or article), a social media post, a survey response, a forum, a reply in a conversation (e.g., conversing with a chatbot or messaging app), a customer complaint, a blog, a profile description, etc. The training enables the compose generative language model 852 to properly take into account the extra context that was extracted from the web page 834 and from the local user profile data 855 and/or central user profile data 842. The training also enables the compose generative language model 852 to generate a response tailored for the purpose, e.g., to generate a response that is similar in length to an average product review, an average social media post, an average forum contribution, etc. Thus, the compose generative language model 852 may leverage the input signals (context about the web page, the text input field, and/or the user) to tailor the output based on the provided browser signals. The compose generative language model 852 may thus be fine-tuned to produce the correct writing structure based on this context for the user provided prompt. For example, if the user is on a product review page and provides a limited prompt, the system (e.g., browser application 808) may add sufficient context such that the generated text from the compose generative language model 852 will be a structured review containing the details from the user prompt. The compose assistant thus provides a solution that leverages page context to prompt users based on goal, categories, topics/themes, etc.

In some implementations, the compose assistant manager may leverage previous prompts and submitted examples from the user's interaction (e.g., stored in local user profile data 855) to personalize the voice further for the user. This is referred to as prompt packing. This will ensure the tone and voice is more consistent across the individual user experience. With user permission, these additional user signals can be synced with a user profile across devices (e.g., user device 802) on which the user is signed in to make the tone and voice consistent across user devices.

In some implementations, the compose generative language model 852 may be configured to generate a response with variable placeholders. For example, if the text box is part of a conversation (e.g., a message in an instant-message conversation or a chat with a chatbot) the user may be responding to a request for a specific piece of information (e.g., a fact). The request for the fact may be part of the context provided to the compose generative language model 852. The compose generative language model 852 may be configured to generate an appropriate variable placeholder in the generated response for the specific piece of information. Thus, for example, the response may be “Thanks! You can reach me at [phone number] after 5 pm” where [phone number] is a variable placeholder the user can edit.

In some implementations, with user permission, additional user context available within the browser (via the profile and other user data stores—represented by the local user profile data 855) may allow the compose assistant to automatically fill variable placeholders in the generated response. For example, when replying to a post regarding contact information, the compose generative language model 852 may output a variable placeholder of [user_x_address], which the browser application 808 will then leverage by looking at the contact information available in the local user profile data 855 to prepopulate the value into the generated response.

The compose generative language model 852 may be trained with examples for different types of input fields, i.e., for input fields with different types of purposes. Because the compose generative language model 852 is trained for directed tasks, it can be small and provides output faster than general purpose large language models.

In some implementations the server computer 860 is not needed because the compose generative language model 852 runs on device, e.g., on the user device 802. In such implementations, functionality performed by the compose service 844 and/or policy filter 846 may be performed by one of the compose assistant components of the browser application 808, e.g., the compose component 810 and/or compose renderer helper 827.

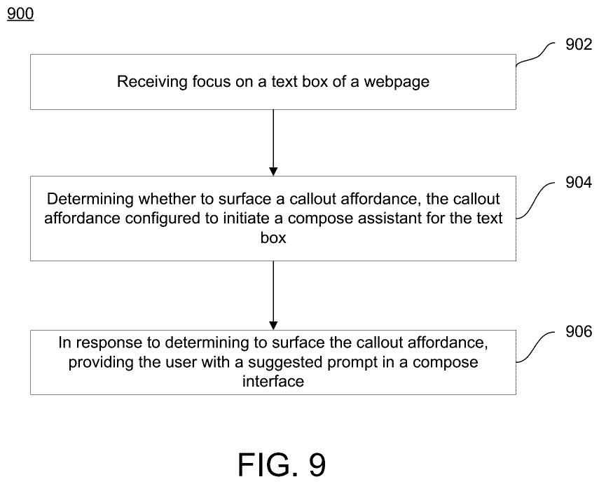

FIG. 9 is a flowchart illustrating an example process 900 for providing a compose assistant, according to an implementation. The process 900 may be performed by a compose assistant manager of a browser, such as the browser application 108 of FIGS. 1A to 1I and/or the browser application 808 of FIG. 9. At step 902, the system receives focus on a text box of a web page. At step 904, the system determines whether to surface a callout affordance, the callout affordance configured to initiate a compose assistant for the text box. At step 906, in response to determining to surface the callout affordance, the system provides the user with a suggested prompt in a compose assistant interface.

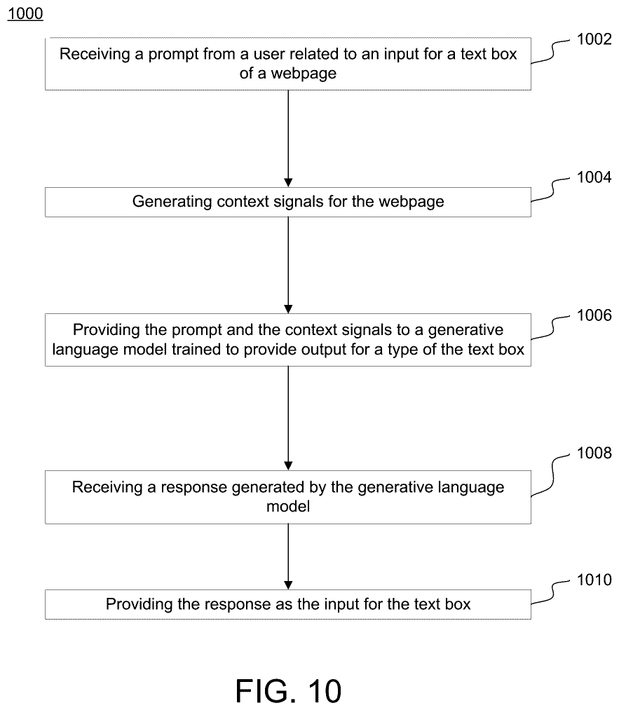

FIG. 10 is a flowchart of an example process 1000 for providing a compose assistant manager, according to an implementation. The process 1000 may be performed by a compose assistant manager of a browser, such as a browser application 108 of FIGS. 1A to 1I and/or a browser application 808 of FIG. 8. At step 1002, the system may receive a prompt from a user related to an input for a text box of a web page. At step 1004, the system may generate context signals for the web page. The context signals can include content signals. The context signals can include user signals. At step 1006, the system may provide the prompt and the context signals to a generative language model trained to provide output for a type (purpose) of the text box. At step 1008, the system may receive a response generated by the generative language model. At step 1010, e.g., in response to selection of an accept control, the system may provide the response as the input for the text box. Thus, using process 1000 the user minimizes the interactions with the computing device and the model is able to generate a high-quality output appropriate for the purpose of the text box.

Example use cases for disclosed implementations are provided below. The use cases are non-limiting examples. Implementations can assist users with specific problems, such as writer's block. For example, a user who likes to share content to stay in touch with her friends and family, consumes a piece of content that is funny but might not have something witty to say to share it across social platforms. The compose assistant can help this user draft something to share. As another example, a user may have recently had a negative experience with an airline and wants to file a complaint. The compose assistant can provide help in articulating his concern effectively and professionally. As another example, a user may be a blogger and social media influencer, but is experiencing writer's block and needs inspiration for their next blog post or social media post. They want to ensure that the content they produce is engaging and relevant to their audience. As another example, a user may have recently moved to an English-speaking country, and needs to write emails, job applications, and other documents in English. The compose assistant can help her draft these. As another example, a user may be a brand manager, and needs to provide daily content inspiration for the company he represents. He must maintain consistency in the brand's voice across various platforms. The compose assistant can ensure consistency across platforms, with his consent. As another example, a user may be a college student, and needs to write a research paper, and is struggling with organizing their thoughts.

FIG. 11 is a flowchart 1100 depicting example operations of a system for integrating a language model in a browser application according to an aspect. The flowchart 1100 may depict operations of a computer-implemented method. The flowchart 1100 may be applicable to any of the implementations discussed herein. Although the flowchart 1100 of FIG. 11 illustrates the operations in sequential order, it will be appreciated that this is merely an example, and that additional or alternative operations may be included. Further, operations of FIG. 11 and related operations may be executed in a different order than that shown, or in a parallel or overlapping fashion.

Operation 1102 includes receiving a prompt from a user related to an input for a text field of a web page. In some examples, the prompt is referred to as textual data, and the web page is referred to as digital content. Operation 1104 includes generating context signals for the web page. In some examples, the context signals are referred to as context data. Operation 1106 includes providing the prompt and the context signals to a generative language model. Operation 1108 includes receiving a response generated by the generative language model. Operation 1110 includes providing the response as the input for the text field. In some examples, the operation 1110 includes providing the response as a suggestion for the input for the text field. In some examples, in response to acceptance of the response, the application may directly insert the response into the text field.

Clause 1. A method comprising: receiving textual data from a user related to an input for a text field of digital content displayed on a user device; generating context data about the digital content; providing the textual data and the context data to a generative language model; receiving a response generated by the generative language model; and providing the response as a suggestion for the input for the text field.

Clause 2. The method of clause 1, further comprising: detecting an interaction with the text field; and determining, by a model, whether to render a callout affordance, the callout affordance, when selected, configured to render a compose assistant interface for the text field, the compose assistant interface having an input field configured to receive the textual data from the user.

Clause 3. The method of clause 2, further comprising: determining whether to render the callout affordance based on signals, the signals including one or more signals about the text field, one or more signals about the digital content, or one or more signals about the user and other users of a compose assistant.

Clause 4. The method of clause 1, further comprising: in response to an amount of the textual data inputted by the user into the text field achieving a threshold level, rendering a callout affordance, the callout affordance, when selected, configured to render a compose assistant interface for the text field, the compose assistant interface having an input field with the textual data.

Clause 5. The method of clause 1, further comprising: receiving a selection to a user interface object with respect to the text field of the digital content; rendering a compose assistant interface for the text field, the compose assistant interface having an input field configured to receive the textual data from the user; and in response to selection of a generate control of the compose assistant interface, transmitting the textual data and the context data to the generative language model.

Clause 6. The method of clause 1, further comprising: receiving a selection of the textual data inputted by the user into the text field; and rendering a compose assistant interface with a control, which when selected, causes transmission of the textual data and the context data to the generative language model.

Clause 7. The method of clause 1, further comprising: in response to an amount of the textual data inputted by the user into the text field achieving a threshold level, transmitting the textual data and the context data; and providing the response as a suggestion in a compose assistant interface.

Clause 8. The method of clause 7, further comprising: detecting a cursor position on the suggestion; and providing a preview of the response in the text field.

Clause 9. The method of clause 1, further comprising: inserting the response into the text field.

Clause 10. The method of clause 1, wherein the digital content is a web page, the method further comprising: retrieving first page content of the web page; retrieving second page content of a web page embedded into the web page; and generating the context data to include the first page content and the second page content.

Clause 11. The method of clause 1, wherein the digital content is a web page, the method further comprising: retrieving a document object model (DOM) representation of the web page; extracting a DOM portion from the DOM representation; and generating the context data to include the DOM portion.

Clause 12. The method of clause 1, wherein the digital content is a web page, the method further comprising: retrieving an accessible content structure of the web page; and generating the context data to include the accessible content structure.

Clause 13. An apparatus comprising: at least one processor; and a non-transitory computer-readable medium storing executable instructions that cause at the at least one processor to execute operations, the operations comprising: receiving textual data from a user related to an input for a text field of digital content displayed on a user device; generating context data about the digital content; providing the textual data and the context data to a generative language model; receiving a response generated by the generative language model; and providing the response as a suggestion for the input for the text field.

Clause 14. The apparatus of clause 13, wherein the operations further comprise: determining, by a model, whether to render a callout affordance based on signals, the signals including one or more signals about the text field, one or more signals about the digital content, or one or more signals about the user and other users of a compose assistant, the callout affordance, when selected, configured to render a compose assistant interface for the text field, the compose assistant interface having an input field configured to receive the textual data from the user.

Clause 15. The apparatus of clause 13, wherein the operations further comprise: in response to an amount of the textual data inputted by the user into the text field achieving a threshold level, rendering a callout affordance, the callout affordance, when selected, configured to render a compose assistant interface for the text field, the compose assistant interface having an input field with the textual data.

Clause 16. The apparatus of clause 13, wherein the operations further comprise: receiving a selection to a user interface object with respect to the text field of the digital content; and rendering a compose assistant interface for the text field, the compose assistant interface having an input field configured to receive the textual data from the user.

Clause 17. The apparatus of clause 13, wherein the digital content is a web page, wherein the operations further comprise: retrieving first page content of the web page; retrieving second page content of a web page embedded into the web page; and generating the context data to include the first page content and the second page content.

Clause 18. A non-transitory computer-readable medium storing executable instructions that cause at least one processor to execute operations, the operations comprising: receiving textual data from a user related to an input for a text field of digital content displayed on a user device; generating context data for the digital content; providing the textual data and the context data to a generative language model; receiving a response generated by the generative language model; and providing the response as a suggestion for the input for the text field.

Clause 19. The non-transitory computer-readable medium of clause 18, wherein the operations further comprise: determining, by a model, whether to render a callout affordance, the callout affordance, when selected, configured to render a compose assistant interface for the text field, the compose assistant interface having an input field configured to receive the textual data from the user.

Clause 20. The non-transitory computer-readable medium of clause 18, wherein the digital content is a web page, wherein the operations further comprise: retrieving first page content of the web page; retrieving second page content of a web page embedded into the web page; and generating the context data to include the first page content and the second page content.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described herein), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

A number of implementations have been described. Nevertheless, it will be understood that various modifications may be made without departing from the spirit and scope of the disclosed implementations.

In addition, the logic flows depicted in the figures do not require the particular order shown, or sequential order, to achieve desirable results. In addition, other steps may be provided, or steps may be eliminated, from the described flows, and other components may be added to, or removed from, the described systems.

In some aspects, the techniques described herein relate to a method including: receiving focus on a text box of a web page; determining whether to surface a callout affordance, the callout affordance configured to initiate a compose assistant for the text box; in response to determining to surface the callout affordance, providing the user with a suggested prompt in a compose assistant interface. The suggested prompt may be based on the context of the web page.

In some aspects, the techniques described herein relate to a method including: receiving a prompt from a user related to an input for a text box of a web page; generating context signals for the web page; providing the prompt and the context signals to a generative language model trained to provide output for a type of the text box; and receiving a response generated by the generative language model; and providing the response as the input for the text box.

In some aspects, the techniques described herein relate to a non-transitory computer-readable medium storing instructions that, when executed by a processor, perform any of the operations or methods disclosed herein.

In some aspects, the techniques described herein relate to a computing device comprising at least one processor and a memory storing instructions that cause the computing device to perform any of the operations or methods disclosed herein.

1. A method comprising:
receiving textual data from a user related to an input for a text field of digital content displayed on a user device;
generating context data about the digital content;
providing the textual data and the context data to a generative language model;
receiving a response generated by the generative language model; and
providing the response as a suggestion for the input for the text field.

2. The method of claim 1, further comprising:
detecting an interaction with the text field; and
determining, by a model, whether to render a callout affordance, the callout affordance, when selected, configured to render a compose assistant interface for the text field, the compose assistant interface having an input field configured to receive the textual data from the user.

3. The method of claim 2, further comprising:
determining whether to render the callout affordance based on signals, the signals including one or more signals about the text field, one or more signals about the digital content, or one or more signals about the user and other users of a compose assistant.

4. The method of claim 1, further comprising:
in response to an amount of the textual data inputted by the user into the text field achieving a threshold level, rendering a callout affordance, the callout affordance, when selected, configured to render a compose assistant interface for the text field, the compose assistant interface having an input field with the textual data.

5. The method of claim 1, further comprising:
receiving a selection to a user interface object with respect to the text field of the digital content;
rendering a compose assistant interface for the text field, the compose assistant interface having an input field configured to receive the textual data from the user; and
in response to selection of a generate control of the compose assistant interface, transmitting the textual data and the context data to the generative language model.

6. The method of claim 1, further comprising:
receiving a selection of the textual data inputted by the user into the text field; and
rendering a compose assistant interface with a control, which when selected, causes transmission of the textual data and the context data to the generative language model.

7. The method of claim 1, further comprising:
in response to an amount of the textual data inputted by the user into the text field achieving a threshold level, transmitting the textual data and the context data; and
providing the response as a suggestion in a compose assistant interface.

8. The method of claim 7, further comprising:
detecting a cursor position on the suggestion; and
providing a preview of the response in the text field.

9. The method of claim 1, further comprising:
inserting the response into the text field.

10. The method of claim 1, wherein the digital content is a web page, the method further comprising:
retrieving first page content of the web page;
retrieving second page content of a web page embedded into the web page; and
generating the context data to include the first page content and the second page content.

11. The method of claim 1, wherein the digital content is a web page, the method further comprising:
retrieving a document object model (DOM) representation of the web page;
extracting a DOM portion from the DOM representation; and
generating the context data to include the DOM portion.

12. The method of claim 1, wherein the digital content is a web page, the method further comprising:
retrieving an accessible content structure of the web page; and
generating the context data to include the accessible content structure.

13. An apparatus comprising:
at least one processor; and
a non-transitory computer-readable medium storing executable instructions that cause at the at least one processor to execute operations, the operations comprising:
receiving textual data from a user related to an input for a text field of digital content displayed on a user device;
generating context data about the digital content;
providing the textual data and the context data to a generative language model;
receiving a response generated by the generative language model; and
providing the response as a suggestion for the input for the text field.

14. The apparatus of claim 13, wherein the operations further comprise:
determining, by a model, whether to render a callout affordance based on signals, the signals including one or more signals about the text field, one or more signals about the digital content, or one or more signals about the user and other users of a compose assistant, the callout affordance, when selected, configured to render a compose assistant interface for the text field, the compose assistant interface having an input field configured to receive the textual data from the user.

15. The apparatus of claim 13, wherein the operations further comprise:
in response to an amount of the textual data inputted by the user into the text field achieving a threshold level, rendering a callout affordance, the callout affordance, when selected, configured to render a compose assistant interface for the text field, the compose assistant interface having an input field with the textual data.

16. The apparatus of claim 13, wherein the operations further comprise:
receiving a selection to a user interface object with respect to the text field of the digital content; and
rendering a compose assistant interface for the text field, the compose assistant interface having an input field configured to receive the textual data from the user.

17. The apparatus of claim 13, wherein the digital content is a web page, wherein the operations further comprise:
retrieving first page content of the web page;
retrieving second page content of a web page embedded into the web page; and
generating the context data to include the first page content and the second page content.

18. A non-transitory computer-readable medium storing executable instructions that cause at least one processor to execute operations, the operations comprising:
receiving textual data from a user related to an input for a text field of digital content displayed on a user device;
generating context data for the digital content;
providing the textual data and the context data to a generative language model;
receiving a response generated by the generative language model; and
providing the response as a suggestion for the input for the text field.

19. The non-transitory computer-readable medium of claim 18, wherein the operations further comprise:
determining, by a model, whether to render a callout affordance, the callout affordance, when selected, configured to render a compose assistant interface for the text field, the compose assistant interface having an input field configured to receive the textual data from the user.

20. The non-transitory computer-readable medium of claim 18, wherein the digital content is a web page, wherein the operations further comprise:
retrieving first page content of the web page;
retrieving second page content of a web page embedded into the web page; and
generating the context data to include the first page content and the second page content.
